(19) United States
(12) Patent Application Publication
(10) Pub. No.: US 2026/0131554 A1
(43) Pub. Date: May 14, 2026

(54) COMPOSITE GEOTEXTILE APPARATUS WITH WICKING PROPERTIES

(71) Applicant: Titan Environmental Containment Ltd., Ile des Chenes (CA)

(72) Inventors: Surinder Bhat, Ile des Chenes (CA); Zhu Xiaoming, Ile des Chenes (CA)

(21) Appl. No.: 18/947,129

(22) Filed: Nov. 14, 2024

(51) Int. Cl. B32B 3/26; B32B 5/02; B32B 37/06; B32B 38/00

(52) U.S. Cl. CPC B32B 3/266; B32B 5/022; B32B 37/06; B32B 38/164; B32B 2262/0276; B32B 2307/514; B32B 2307/54; B32B 2307/718; B32B 2307/728; B32B 2307/7376; B32B 2309/02; B32B 2309/12

(57) ABSTRACT

A composite geotextile apparatus for reinforcement of subgrade materials under dynamic loading includes a geogrid layer bonded alongside a geotextile layer. The geogrid layer is formed of polymeric material defining an array of apertures therein and provides biaxial tensile reinforcement. The geotextile layer is formed of (i) continuous filaments formed of a polyester material distributed in a non-woven sheet and (ii) a chemical agent applied to the polyester material of the non-woven sheet such that the polyester material is rendered more hydrophilic. The composite geotextile apparatus has a unique microstructure of fibers and a chemical treatment to facilitate wicking in all directions across the geotextile. The composite geotextile apparatus provides superior long-term performance in water management applications, particularly in road construction, while maintaining the functions of conventional nonwoven geotextiles, such as filtration and separation.

### FIELD OF THE INVENTION

The present invention relates to a composite geotextile apparatus including a geogrid layer of polymeric material defining an array of apertures therein and non-woven geotextile layer bonded to the geogrid layer, and more particularly the present invention relates to a composite geotextile apparatus arranged to wick moisture along the geotextile layer in all directions under a zero gradient such that the composite geotextile apparatus is suited for reinforcement of partly saturated weak subgrade soils under load in engineered structures, for example roadways, for both reinforcing the subgrade soils wicking moisture away from the subgrade soils.

### BACKGROUND

In the construction of various engineered structures, for example road construction and maintenance, frequent repairs leading to high maintenance costs and disruptions are commonplace, particularly in areas where the subgrade includes soft and weak soils that may be partly or fully saturated with moisture and subjected to freeze-thaw cycles. In the presence of excess water in the subgrade soils, the dynamic loading, for example passing vehicles, and freeze-thaw cycles contribute to undesirable movement in the subgrade soils that lead to deterioration of the engineered structure.

Use of a geogrid in the form of an open aperture polymeric member is a known type of reinforcement used within aggregate base layers under engineered structures, but a geogrid is not suitable for reinforcement of weak soils.

Geotextiles are also commonly used in various applications in the form sheets of woven or non-woven fibers forming a fabric layer that can perform various functions when layered in weak soils including separation, filtration, reinforcement, and protection. Conventional geotextiles can readily deteriorate in the presence of excess water in the subgrade soils though.

In one known example, hydrophilic and hygroscopic deep groove yarns are woven into a woven geotextile to facilitate wicking by capillary action to create a wicking action limited to the direction of the yarns.

### SUMMARY OF THE INVENTION

According to one aspect of the invention there is provided a composite geotextile apparatus for reinforcement of subgrade materials under dynamic loading, the apparatus comprising:
a geogrid layer formed of polymeric material defining an array of apertures therein and providing biaxial tensile reinforcement; and
a geotextile layer bonded alongside the geogrid layer, the geotextile layer being formed of (i) continuous filaments formed of a polyester material distributed in a non-woven sheet and (ii) a chemical agent applied to the polyester material of the non-woven sheet such that the polyester material is rendered more hydrophilic whereby the geotextile layer is arranged to wick moisture along the geotextile layer in all directions under a zero gradient.

The composite geotextile apparatus provides an entirely new approach of modification of a non-woven PET geotextile by creating a unique microstructure of fibers and applying a chemical treatment to facilitate wicking in all directions across the geotextile.

The apparatus described herein provides superior long-term performance in water management applications, particularly in road construction, while maintaining the functions of conventional nonwoven geotextiles, such as filtration and separation. By improving road durability, the apparatus reduces maintenance costs and enhances the safety and reliability of transportation infrastructure while greatly reducing the carbon footprint.

As described herein, the composite geotextile apparatus has the following benefits: (i) withstanding freeze-thaw cycles and water Infiltration, (ii) mitigation of thaw induced differential displacement, (iii) increased bearing capacity and stabilization of low load bearing soils, (vi) significant embodied carbon (EC) reduction fostering sustainability, and (v) suitability for transporting water and homogenizing the moisture content over peat and other such very weak, saturated and variable sub-grades, subjected to heavy dynamic loading for roads/land development areas, parking lots, access/haul roads/paved roads, railway embankments, airport runways/taxiways constructions.

The apparatus is suited for use in combination with an engineered structure comprising an aggregate base layer deposited on a subgrade layer including a weak soil that is at least partially saturated with moisture, in which the composite geotextile apparatus is deposited on the subgrade layer below the aggregate base layer. The apparatus is further suited for use in applications where the subgrade layer is subjected to seasonal freeze and thaw cycles. In preferred applications, the engineered structure comprises a road extending lengthwise in a road direction, and the composite geotextile apparatus is elongated in a longitudinal direction in which the longitudinal direction extends in said road direction.

The dried chemical agent may be an oil preparation comprising: (i) natural lauric acid polyoxyethylene ester in a range of 0 to 37.5% of the chemical agent by mass; (ii) natural fatty alcohol polyoxyethylene ether in a range of 0 to 7.5% of the chemical agent by mass; (iii) castor oil polyoxygen in a range of 0 to 18.75% of the chemical agent by mass; (iv) polyether amine in a range of 0 to 26.25% of the chemical agent by mass; (v) ether in a range of 0 to 30% of the chemical agent by mass; (vi) alcohol ether, in a range of 0 to 7.5% of the chemical agent by mass; and (v) phosphate ester and potassium phosphate ester, in a range of 0 to 22.5% of the chemical agent by mass.

Preferably the chemical agent is retained on the polyester material in a range of 10 to 30 grams per square meter of the non-woven sheet.

When the composite geotextile apparatus is elongated in a longitudinal direction, preferably a majority of the filaments are oriented within 45 degrees of said longitudinal direction, and more preferably 55 to 65% of the filaments are oriented within 45 degrees of said longitudinal direction.

Preferably the filaments have a diameter in a range of 2.5 to 5.0 denier.

Preferably the geotextile is dried with heat such that a portion of the filaments nearest to a surface of the non-woven sheet, in a range of 5 to 15% of all filaments, are elliptical in cross-sectional shape.

According to a second aspect of the present invention there is provided a method of forming a composite geotextile apparatus for reinforcement of subgrade materials under load, the method comprising:
providing a geogrid layer formed of polymeric material defining an array of apertures therein and being arranged to provide biaxial tensile reinforcement;
providing a geotextile layer comprising (i) continuous filaments formed of a polyester material distributed in a non-woven sheet and (ii) a chemical agent applied to the polyester material of the non-woven sheet such that the polyester material is rendered more hydrophilic whereby the geotextile layer is arranged to wick moisture in all directions along the geotextile layer under a zero gradient; and
bonding the geogrid layer alongside the geotextile layer.

The method may further comprise applying the chemical agent to the polyester material in which the chemical agent is an oil preparation comprising (i) natural lauric acid polyoxyethylene ester in a range of 0 to 15% of the chemical agent by mass, (ii) natural fatty alcohol polyoxyethylene ether in a range of 0 to 3% of the chemical agent by mass, (iii) castor oil polyoxygen in a range of 0 to 7.5% of the chemical agent by mass, (iv) polyether amine in a range of 0 to 10.5% of the chemical agent by mass, (v) ether in a range of 0 to 9% of the chemical agent by mass, (vi) alcohol ether in a range of 0 to 3% of the chemical agent by mass, (vii) phosphate ester and potassium phosphate ester in a range of 0 to 9% of the chemical agent by mass, and (viii) soft water in a range of 40 to 80% of the chemical agent by mass. After applying the chemical agent, the method preferably includes drying the chemical agent such that the chemical agent is retained on the polyester material in a range of 10 to 30 grams per square meter of the non-woven sheet, and/or such that a thickness of the non-woven sheet is reduced in a range of 30 to 40%.

When the geogrid comprises a plurality of nodes interconnected by struts, the method preferably includes bonding the geogrid layer alongside the geotextile layer by (i) heating an inner surface of the geogrid layer and (ii) pressing the inner surface of the geogrid layer against the geotextile layer so as to form a stronger bond at the nodes than at the struts.

Preferably the inner surface of the geogrid layer is heated using a heating element operating at a temperature in a range of 180 to 240 degrees Celsius.

The method preferably further includes pressing the inner surface of the geogrid layer against the geotextile layer using pressure in the range of 0 to 20 kPa.

When the composite geotextile apparatus is elongated in a longitudinal direction, the method preferably includes forming the geotextile layer by applying tension in the longitudinal direction such that 55 to 65% of the filaments are oriented within 45 degrees of said longitudinal direction.

The method may further include forming the geotextile layer by applying heat to surfaces of the non-woven sheet such that a portion of the filaments nearest to a surface of the non-woven sheet, in a range of 5 to 15% of all filaments, are deformed in cross-sectional shape from round to elliptical.

The method may further include (i) forming the geotextile layer by applying the chemical agent to the polyester material in a wet form before bonding the geogrid layer alongside the geotextile layer; and (ii) bonding the geogrid layer alongside the geotextile layer by heating an inner surface of the geogrid layer under a prescribed temperature limit and pressing the inner surface of the geogrid layer against the geotextile layer under a prescribed pressure limit such that the geotextile retains an ability to wick along the geotextile layer in both directions along both longitudinal and lateral axes under a zero gradient.

According to a further aspect of the present invention there is provided a method of forming an engineered structure on a subgrade layer including a weak soil that is at least partially saturated with moisture and that is subjected to seasonal freeze and thaw cycles, the method including:
providing a composite geotextile apparatus in which the apparatus includes (i) a geogrid layer formed of polymeric material defining an array of apertures therein and providing biaxial tensile reinforcement and (ii) a geotextile layer bonded alongside the geogrid layer in which the geotextile layer is formed of (a) continuous filaments formed of a polyester material distributed in a non-woven sheet and (b) a chemical agent applied to the polyester material of the non-woven sheet such that the polyester material is rendered more hydrophilic whereby the geotextile layer is arranged to wick moisture along the geotextile layer in all directions under a zero gradient;
depositing the composite geotextile apparatus horizontally on the weak soil of the subgrade layer; and
covering the composite geotextile apparatus with an aggregate layer arranged to receive the engineered structure thereon.

### BRIEF DESCRIPTION OF THE DRAWINGS

One embodiment of the invention will now be described in conjunction with the accompanying drawings in which:

FIG. 1 is a schematic representation of the composite geotextile apparatus in which the geotextile layer and the geogrid layer have been separated for illustrative purposes;

FIG. 2 is a plan view of the composite geotextile apparatus;

FIG. 3 is a sectional view along the line 3-3 in FIG. 2;

FIG. 4 is a schematic representation of a single filament of the geotextile layer varying from round to elliptical in cross-section;

FIG. 5 is a schematic representation of the bonding process for joining the geotextile layer and the geogrid layer to form the composite geotextile apparatus;

FIG. 6 is a sectional elevational view of a roadway construction incorporating the composite geotextile apparatus of FIG. 1 according to one exemplary application of the present invention;

FIG. 7 is a graphical representation of the distribution of secant radial stiffness of the composite geotextile apparatus when undergoing 0.5% strain; and

FIG. 8 is a graphical representation of the distribution of secant radial stiffness of the composite geotextile apparatus when undergoing 2.0% strain.

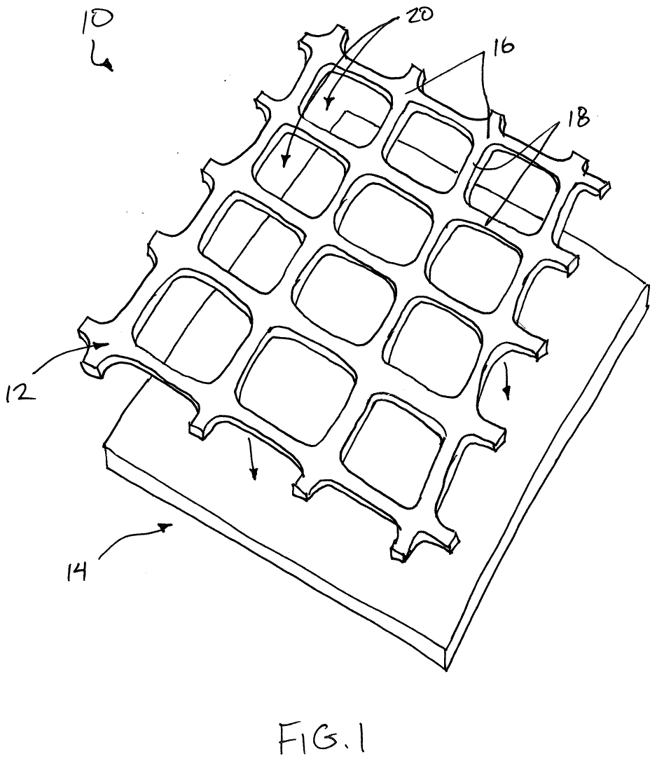

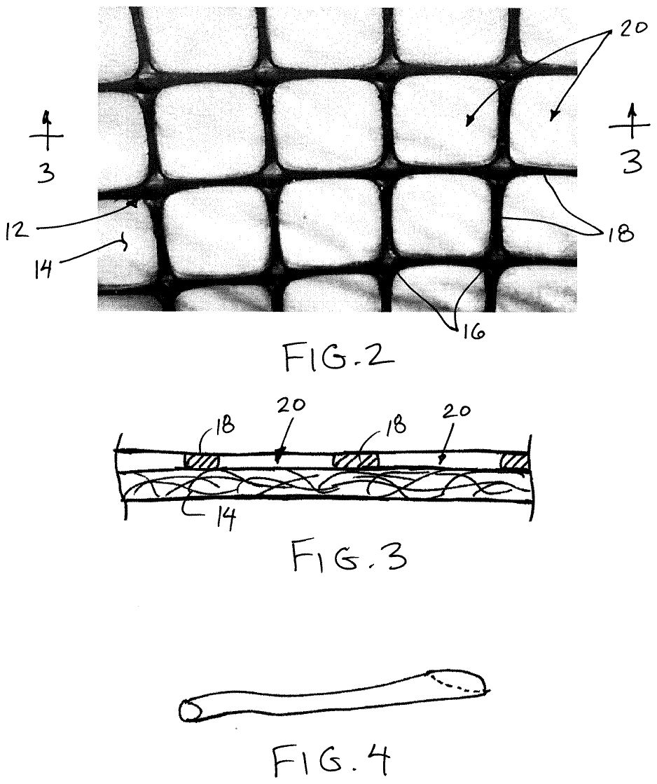

In the drawings like characters of reference indicate corresponding parts in the different figures.

### DETAILED DESCRIPTION

The composite geotextile apparatus 10 according to the present invention is a novel composite material created as a result of bonding an open aperture polymeric geogrid 12 to a non-woven geotextile 14 with wicking properties in addition to the reinforcement and hydraulic properties of the composite material. The non-woven geotextile 14 does not incorporate any other material other than the geotextile material itself to exhibit a wicking function. Wicking as described herein refers to the water movement through the material horizontally and vertically at zero hydraulic gradient.

As described further herein, the wicking mechanism of the apparatus 10 is primarily based on the fiber uniqueness and the microstructure of the non-woven geotextile component, further enhanced by chemical treatment to enable wicking in all directions including in both directions along longitudinal and lateral axes of the geotextile. This mechanism is different from the conventional woven wicking geotextiles that utilize hydrophilic and hygroscopic deep groove yarns to facilitate wicking with capillary action. The apparatus 10 has a unique structure, manufacturing process and chemical treatment of the PET fibers to create a wicking non-woven geotextile to be suitable for transporting water and homogenizing the moisture content over very weak, saturated and variable sub-grades, subjected to heavy dynamic loading, at zero head. The apparatus has high water absorption and fast water movement capabilities and is envisaged to be well suited in various infrastructure applications that require effective and efficient drainage along with moisture management and control especially subjected to freeze thaw cycles.

More particularly, the composite geotextile apparatus 10 is a high stiffness composite geogrid made of biaxial polypropylene (PP), heat bonded to a continuous filament non-woven geotextile with wicking capabilities to transport water against gravity and reduce pore pressure accumulation. The composite geotextile apparatus 10 is specifically designed to resist the freeze-thaw cycles and mitigate thawing induced differential settlements. Wicking facilitates the transportation of water at the zero gradient, therefore reducing the accumulation of pore pressure.

This high stiffness and integrally formed geogrid is monolithic and isotropic with thick and wide ribs, integral nodes, and uniform square apertures and possesses high stiffness at low strains to be ideal for soil stabilization and base reinforcement. Engineered to be mechanically and chemically stable in aggressive soil environments, the composite geotextile apparatus 10 allows sub-base drainage to help maintain structural stability and is highly effective in keeping expensive imported material from being contaminated by migration of fines from the saturated base soils.

Referring to the accompanying figures there is illustrated a composite geotextile apparatus generally indicated by reference numeral 10. The composite geotextile apparatus is constructed by separately forming the geotextile layer 14 and the geogrid layer 12 as separate layers which are subsequently heat bonded to form the composite apparatus 10.

The geotextile layer 14 is a nonwoven sheet formed from continuous filaments of polyethylene terephthalate which are deposited in a random manner to form the sheet. The filaments are initially formed with a circular cross-section with a size in the range of 2.5 to 5.0 denier as the filaments are deposited into a sheet form within a forming machine from which the sheet is drawn in a longitudinal direction corresponding to a machine direction. The resulting formed sheet is elongated in the longitudinal direction. While forming the sheet, tension is applied to the sheet as it is drawn from the forming machine such that some of the randomly distributed filaments are reoriented in the longitudinal direction of applied tension. This results in a final distribution of the filaments being oriented such that between 55 and 65% of the filaments lie within 45 degrees of the longitudinal direction in either one of clockwise or counterclockwise directions away from the longitudinal axis. Accordingly a remaining 35 to 45% of the filaments are oriented within 45 degrees of a lateral axis oriented perpendicularly to the longitudinal direction and corresponding to a crosswise direction of the machine. The sheet may undergo a smoothing or calendaring process as it is withdrawn from the forming machine to produce the sheet form of the geotextile layer.

The geotextile layer 14 is further prepared by applying a chemical treatment in the form of an oil preparation. The oil preparation is initially wetted before application to the PET filaments such that the oil preparation initially comprises (i) natural lauric acid polyoxyethylene ester in a range of 0 to 15% of the chemical agent by mass, (ii) natural fatty alcohol polyoxyethylene ether in a range of 0 to 3% of the chemical agent by mass, (iii) castor oil polyoxygen in a range of 0 to 7.5% of the chemical agent by mass, (iv) polyether amine in a range of 0 to 10.5% of the chemical agent by mass, (v) ether in a range of 0 to 9% of the chemical agent by mass, (vi) alcohol ether in a range of 0 to 3% of the chemical agent by mass, (vii) phosphate ester and potassium phosphate ester in a range of 0 to 9% of the chemical agent by mass, and (viii) soft water in a range of 40 to 80% of the chemical agent by mass.

This wet oil preparation can be applied to the filaments of the geotextile layer by soaking, spraying or otherwise saturating the filaments with the preparation. Once saturated, the geotextile sheet is initially dried with hot air followed by hot calendaring to remove the water content. The chemical agent is retained on the polyester material in a range of 10 to 30 grams per square meter of the surface area of the nonwoven sheet. The resulting dried chemical agent that is retained on the filaments comprises a dried oil preparation including: (i) natural lauric acid polyoxyethylene ester in a range of 0 to 37.5% of the chemical agent by mass; (ii) natural fatty alcohol polyoxyethylene ether in a range of 0 to 7.5% of the chemical agent by mass; (iii) castor oil polyoxygen in a range of 0 to 18.75% of the chemical agent by mass; (iv) polyether amine in a range of 0 to 26.25% of the chemical agent by mass; (v) ether in a range of 0 to 30% of the chemical agent by mass; (vi) alcohol ether, in a range of 0 to 7.5% of the chemical agent by mass; and (vii) phosphate ester and potassium phosphate ester, in a range of 0 to 22.5% of the chemical agent by mass.

The application of the oil preparation renders the polyester filaments of the geotextile layer more hydrophilic than they would otherwise be, producing a combination of hydrophilic and hygrophobic properties on the resulting geotextile layer consisting only of the polyester filaments and the retained oil preparation after drying. This combination of properties attracts water towards the geotextile layer and then subsequently transports the water along the layer primarily in the longitudinal direction corresponding to the orientation of the majority of the filaments. This enables the geotextile layer to wick and transport moisture along the geotextile layer even when the geotextile layer is placed horizontally at a gradient of zero.

The drying and calendaring process involves application of heat to a degree that provides some deformation of the filaments at the broad surfaces of the geotextile layer such that a portion of the filaments at the surface, in the range of 5% to 15% of all filaments in the sheet, are deformed from their initial circular cross-section to on the elliptical cross section. The application of heat is otherwise kept within appropriate temperature limits so as not to detrimentally affect the water transporting properties of the geotextile. The finished geotextile layer remains consisting only of the PET filaments and the retained dried oil preparation so as to provide wicking properties without incorporating any additional grooved yarns or yarns of different materials according to prior art arrangements.

The geogrid layer 12 is formed of a polymer such as polypropylene which is formed into a rectangular grid comprised of nodes 16 interconnected by struts 18 oriented in the longitudinal and lateral directions so as to define an array of rectangular apertures 20. The cumulative area of the apertures 20 is multiple times, for example at least two times, greater than a cumulative area of the struts and the nodes so as to provide substantial drainage through the geogrid layer while providing reinforcement along two axes corresponding to the two directions of the struts. The struts have a widthwise dimension which is less than corresponding dimensions of the nodes such that the nodes have a larger overall cross-sectional area than the individual struts. When bonding the geogrid layer to the geotextile layer, a majority of the bonding force between the layers occurs at the nodes as compared to the struts.

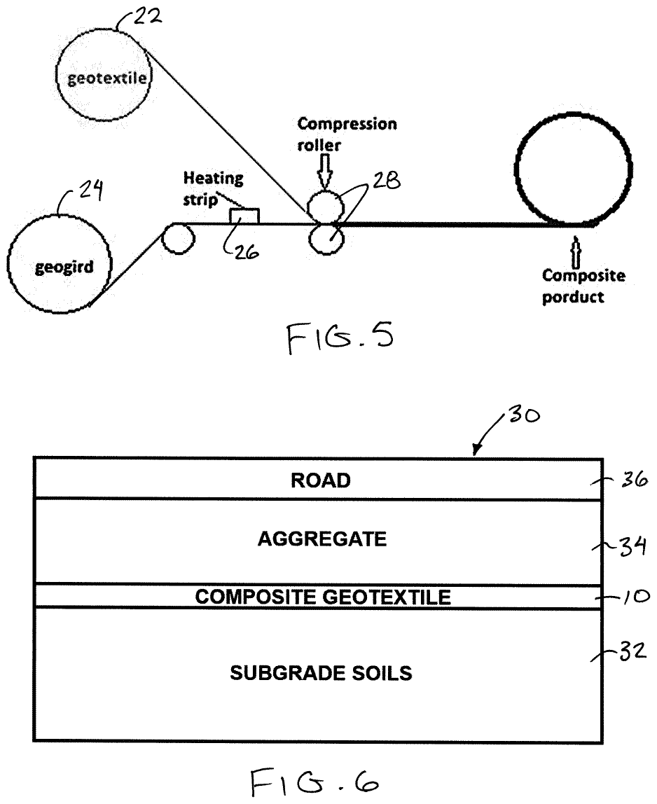

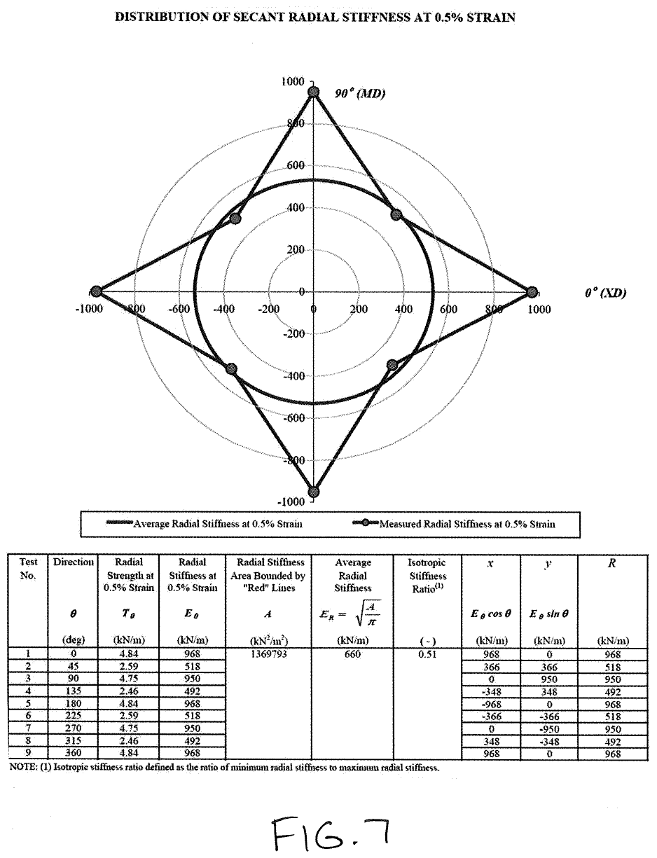

The resulting composite geotextile apparatus is formed in a process schematically represented in FIG. 5. Prior to bonding, the geotextile layer is produced and rolled onto a textile roller 22 while the geogrid is produced and rolled onto a grid roller 24. Material from each of the rollers are drawn together and fed in a machine direction through the bonding machine represented schematically in FIG. 5. The bonding machine includes a heating element 26 formed in individual blade sections which are joined end-to-end to form a continuous strip extending across a full width of the geogrid in the crosswise direction. The heating element is operated at a temperature between 180 and 240 degrees Celsius. The heating element is positioned in close proximity so as to be either directly against or in contact with an inner surface of the geogrid as the geogrid layer is drawn into the bonding machine. The heating element exposes the plastic material of the geogrid to sufficient heat by controlling the speed that the material passes the heating element so as to melt the surface of the plastic material nearest to the geotextile layer prior to joining the sheets.

The geotextile layer 14 and the geogrid layer 12 are brought together by inserting the sheets adjacent one another into the gap between a pair of counter-rotating rollers 28 in which the spacing between the rollers is controlled such that the sheets are merely brought into contact with one another or are pushed together with suitable pressure to press the melted surface layer of plastic material on the geogrid against the surface filaments of the geotextile layer. The applied pressure is kept below a prescribed pressure limit of 20 kPa with the temperature applied by the heating element also being controlled within a prescribed limit so as not to notably detrimentally affect the wicking properties of the chemical treatment applied to the geotextile.

The resulting composite apparatus 10 exhibits wicking properties to transfer or wick water both laterally and longitudinally along the sheet in all directions even when the sheet is horizontally placed at a zero gradient such that the composite apparatus 10 is suitable for use in managing water in layered engineering structures for example. As shown in FIG. 6, in the exemplary construction of a road 30, the road is constructed over a subgrade 32 consisting of soft or weak soils, for example fine particle soils including silt, peat and the like which may be partly or fully saturated with water. In this instance, the composite apparatus 10 is placed horizontally directly over the subgrade soils 32 in contact with the partly or fully saturated soils so that water in the subgrade is transported by the compass of apparatus 10 longitudinally along the geotextile layer. A course aggregate layer 34 can then be placed directly over the compass of apparatus 10 followed by subsequent finer layers of aggregate. A geogrid layer 12 may be optionally incorporated alone without the geotextile layer in between layers of aggregate. Finally road materials 36 are placed above the aggregate layers to form the finished road surface. The road material may be a surface aggregate material that is compacted, asphalt, or concrete and the like. The compass of apparatus 10 is installed such that the longitudinal direction of the apparatus is aligned parallel to the longitudinal direction of the constructed road 30. The apparatus 10 thus acts to transport water longitudinally in the direction of the road and laterally transversely to the road. A terminal structure may be incorporated into the engineered structure alongside or at one or more locations in the longitudinal direction in the form of drainage channels, ditches and the like to receive the transported water and further transport the water away from the engineered structure.

As described herein, the composite geotextile apparatus 10 is a wicking non-woven polyethylene terephthalate geotextile 14 bonded to a polymeric bi-axial geogrid 12 by any means of bonding such as applying glue or heat bonding or by any other method.

In a preferred arrangement the geotextile 14 and the geogrid are joined by a heat bonding process outlined as follows. A line of metal blades, each with a 10 cm width, are posited adjacent one another as a continuous strip which gives heating to an inner surface of the geogrid across the width of the material while the geogrid and wicking geotextile move forwardly until the plastic is melted, followed by touching the wicking geotextile and the geogrid to be laminated together under a certain pressure range from a pair of rollers. This method applies to all kinds of plastic geogrids lamination with wicking non-geotextile. The pressure applied for laminating the composite is from 0-20 kPa, and the temperature range of the heating element applied to the geogrid prior to joining to the geotextile is between 180-240 degrees Celsius.

The chemical treatment preferably comprises applying a chemical agent to the geotextile filaments in which the chemical agent is an oil preparation comprising the following components by mass percentage: 10% of natural lauric acid polyoxyethylene ester, 2% of natural fatty alcohol polyoxyethylene ether, 5% of castor oil polyoxygen, 7% of polyether, amine 8% ether, 2% alcohol ether, 6% phosphate ester and potassium phosphate ester, 60% soft water to form a liquid state which is called “original liquid”. 8% to 14% of the original liquid is used as a component mix with soft water again for soaking the nonwoven geotextile before initially drying the nonwoven geotextile using hot wind blowing the surface of the wet geotextile. A hot calendaring method is then used for further drying of the wet geotextile until the water content is substantially removed from the geotextile structure.

In the geotextile 14, the filament diameter is preferably between 2.5-5.0 Denier.

The non-woven geotextile filaments at the surface of the sheet, in the range of 5 to 15% of total filaments, change their shape from round to elliptic as a result of heat applied in drying the non-woven sheet.

A minimum of 10 grams per square meter (gsm) up to 30 gsm of the chemical oiling agent are retained on the geotextile filaments after drying the filaments.

Thickness of the geotextile layer before treatment is reduced by 30% to 40% after chemical treatment drying.

Regarding the orientation of the fibers, around 55% to 65% of the filaments are within the 45 degrees in either clockwise and anticlockwise directions from the machine direction. Accordingly, the remaining 35% to 45% of the total filaments are within 45 degrees in either clockwise and anticlockwise directions from the crosswise direction.

The fibers of composite geotextile apparatus 10 are randomly distributed, and the filament diameter is controlled within a specific band. These fibers are continuous filaments.

In the manufacturing process, the now-woven surface filaments in the geotextile 14 de-shape from round to elliptic. This is attributed to the drying process; the filaments may semi melt and after the fabric is subjected to calendaring.

The orientation of the fibers in the geotextile 14 has been achieved after several repeats of the chemical treating and drying process, in which the fabric is tensioned in a machine direction so that some filaments laying in the cross-machine direction are dragged towards the machine direction, so it will be easier for water to flow along the machine direction. In contrast to prior art non-wicking geotextiles having strengths that are quite similar in both directions, the non-woven geotextile 14 according to the present invention, for the same per unit area, has higher mechanical properties in both directions, with a lower apparent opening size, while still having a high flow rate of wicking moisture.

The composite geotextile apparatus has been created to work in engineered applications to transport water at a fast rate at zero head on the weak saturated sub-grades, subjected to heavy dynamic and repeated loading and to resist freeze thaw, such as roads, embankments, highways in contrast to any other known wicking geotextiles that have been used only in landscaping applications which minimal loading is required.

Mechanical properties for the geotextile after chemical treatment results in a 5% to 15% reduction in strength after treatment.

The total of wet front horizontal movement obtained is 90-106 inches, at the duration of 4805 minutes.

The horizontal wet-front velocity starts with 360 inches/hour at the duration of one minute and reduces to 90 inches/hour at the duration of 15 minutes. Movement continues with the reduction in the velocity until 4,805 minutes are elapsed.

The total vertical wet front movement obtained is 2 inches at 545 minutes.

The vertical wet front velocity starts with 90 inches/hour at 0.75 inches and movement continues with the reduction in velocity until 545 minutes are elapsed.

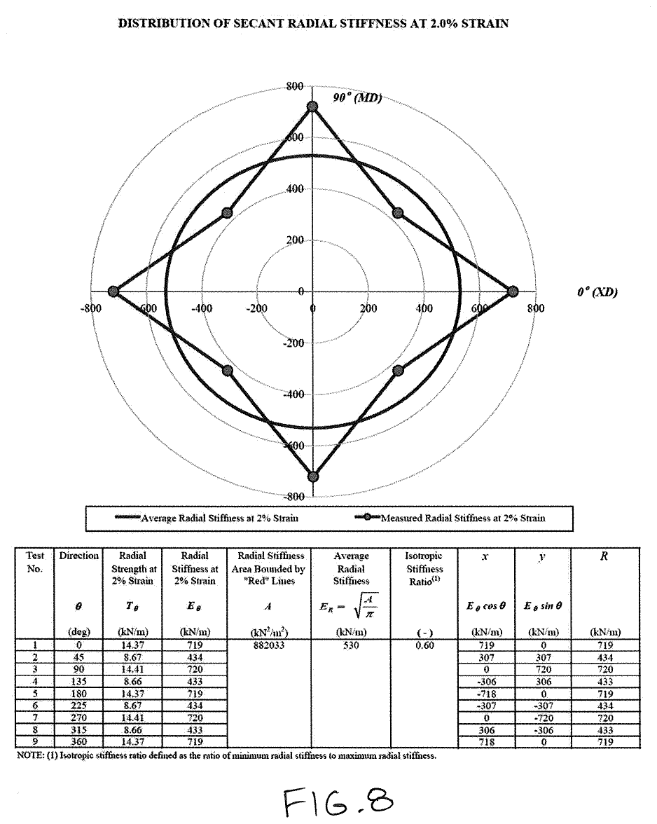

As shown in FIGS. 7 and 8 mechanical properties of the composite geotextile apparatus include an average radial stiffness of >500 kN/m at 0.5% strain and an average radial stiffness of >400 kN/m at 2% strain.

Since various modifications can be made in the invention as herein above described, and many apparently widely different embodiments of same made, it is intended that all matter contained in the accompanying specification shall be interpreted as illustrative only and not in a limiting sense.

1. A composite geotextile apparatus for reinforcement of subgrade materials under load, the apparatus comprising:
a geogrid layer formed of polymeric material defining an array of apertures therein and providing biaxial tensile reinforcement; and
a geotextile layer bonded alongside the geogrid layer, the geotextile layer being formed of (i) continuous filaments formed of a polyester material distributed in a non-woven sheet and (ii) a chemical agent applied to the polyester material of the non-woven sheet such that the polyester material is rendered more hydrophilic whereby the geotextile layer is arranged to wick moisture in all directions along the geotextile layer under a zero gradient.

2. The apparatus according to claim 1 in combination with an engineered structure comprising an aggregate base layer deposited on a subgrade layer including a weak soil that is at least partially saturated with moisture, wherein the composite geotextile apparatus is deposited on the subgrade layer below the aggregate base layer.

3. The apparatus according to claim 2 wherein the subgrade layer is subjected to seasonal freeze and thaw cycles.

4. The apparatus according to claim 2 wherein the engineered structure comprises a road extending lengthwise in a road direction, and wherein the composite geotextile apparatus is elongated in a longitudinal direction in which the longitudinal direction extends in said road direction.

5. The apparatus according to claim 1 wherein the dried chemical agent is an oil preparation comprising:
natural lauric acid polyoxyethylene ester in a range of 0 to 37.5% of the chemical agent by mass;
natural fatty alcohol polyoxyethylene ether in a range of 0 to 7.5% of the chemical agent by mass;
castor oil polyoxygen in a range of 0 to 18.75% of the chemical agent by mass;
polyether amine in a range of 0 to 26.25% of the chemical agent by mass;
ether in a range of 0 to 30% of the chemical agent by mass;
alcohol ether, in a range of 0 to 7.5% of the chemical agent by mass; and
phosphate ester and potassium phosphate ester, in a range of 0 to 22.5% of the chemical agent by mass.

6. The apparatus according to claim 1 wherein the chemical agent is retained on the polyester material in a range of 10 to 30 grams per square meter of the non-woven sheet.

7. The apparatus according to claim 1 wherein the composite geotextile apparatus is elongated in a longitudinal direction and wherein a majority of the filaments are oriented within 45 degrees of said longitudinal direction.

8. The apparatus according to claim 7 wherein 55 to 65% of the filaments are oriented within 45 degrees of said longitudinal direction.

9. The apparatus according to claim 1 wherein the filaments have a diameter in a range of 2.5 to 5.0 denier.

10. The apparatus according to claim 1 wherein a portion of the filaments nearest to a surface of the non-woven sheet, in a range of 5 to 15% of all filaments, are elliptical in cross-sectional shape.

11. A method of forming a composite geotextile apparatus for reinforcement of subgrade materials under load, the method comprising:
providing a geogrid layer formed of polymeric material defining an array of apertures therein and being arranged to provide biaxial tensile reinforcement;
providing a geotextile layer comprising (i) continuous filaments formed of a polyester material distributed in a non-woven sheet and (ii) a chemical agent applied to the polyester material of the non-woven sheet such that the polyester material is rendered more hydrophilic whereby the geotextile layer is arranged to wick moisture in all directions along the geotextile layer under a zero gradient; and
bonding the geogrid layer alongside the geotextile layer.

12. The method according to claim 11 further comprising:
applying the chemical agent to the polyester material in which the chemical agent is an oil preparation comprising (i) natural lauric acid polyoxyethylene ester in a range of 0 to 15% of the chemical agent by mass, (ii) natural fatty alcohol polyoxyethylene ether in a range of 0 to 3% of the chemical agent by mass, (iii) castor oil polyoxygen in a range of 0 to 7.5% of the chemical agent by mass, (iv) polyether amine in a range of 0 to 10.5% of the chemical agent by mass, (v) ether in a range of 0 to 9% of the chemical agent by mass, (vi) alcohol ether in a range of 0 to 3% of the chemical agent by mass, (vii) phosphate ester and potassium phosphate ester in a range of 0 to 9% of the chemical agent by mass, and (viii) soft water in a range of 40 to 80% of the chemical agent by mass;
drying the chemical agent such that the chemical agent is retained on the polyester material in a range of 10 to 30 grams per square meter of the non-woven sheet.

13. The method according to claim 12 further comprising drying the chemical agent such that a thickness of the non-woven sheet is reduced in a range of 30 to 40%.

14. The method according to claim 11 wherein the geogrid comprises a plurality of nodes interconnected by struts, and wherein the method further comprises bonding the geogrid layer alongside the geotextile layer by (i) heating an inner surface of the geogrid layer and (ii) pressing the inner surface of the geogrid layer against the geotextile layer so as to form a stronger bond at the nodes than at the struts.

15. The method according to claim 14 further comprising heating the inner surface of the geogrid layer using a heating element operating at a temperature in a range of 180 to 240 degrees Celsius.

16. The method according to claim 14 further comprising pressing the inner surface of the geogrid layer against the geotextile layer using pressure in the range of 0 to 20 kPa.

17. The method according to claim 11 wherein the composite geotextile apparatus is elongated in a longitudinal direction and wherein the method includes forming the geotextile layer by applying tension in the longitudinal direction such that 55 to 65% of the filaments are oriented within 45 degrees of said longitudinal direction.

18. The method according to claim 11 further comprising forming the geotextile layer by applying heat to surfaces of the non-woven sheet such that a portion of the filaments nearest to a surface of the non-woven sheet, in a range of 5 to 15% of all filaments, are deformed in cross-sectional shape from round to elliptical.

19. The method according to claim 11 further comprising
forming the geotextile layer by applying the chemical agent to the polyester material in a wet form before bonding the geogrid layer alongside the geotextile layer; and
bonding the geogrid layer alongside the geotextile layer by heating an inner surface of the geogrid layer under a prescribed temperature limit and pressing the inner surface of the geogrid layer against the geotextile layer under a prescribed pressure limit such that the geotextile retains an ability to wick along the geotextile layer under a zero gradient.

20. A method of forming an engineered structure on a subgrade layer including a weak soil that is at least partially saturated with moisture and that is subjected to seasonal freeze and thaw cycles, the method including:
providing a composite geotextile apparatus in which the apparatus includes (i) a geogrid layer formed of polymeric material defining an array of apertures therein and providing biaxial tensile reinforcement and (ii) a geotextile layer bonded alongside the geogrid layer in which the geotextile layer is formed of (a) continuous filaments formed of a polyester material distributed in a non-woven sheet and (b) a chemical agent applied to the polyester material of the non-woven sheet such that the polyester material is rendered more hydrophilic whereby the geotextile layer is arranged to wick moisture in all directions along the geotextile layer under a zero gradient;
depositing the composite geotextile apparatus horizontally on the weak soil of the subgrade layer; and
covering the composite geotextile apparatus with an aggregate layer arranged to receive the engineered structure thereon.
